(19) United States
(12) Patent Application Publication
(10) Pub. No.: US 2015/0242403 A1
(43) Pub. Date: Aug. 27, 2015

(54) SOCIALLY INTEGRATED OPERATIONS LOG METHOD AND SERVICE

(71) Applicant: International Business Machines Corporation, Armonk, NY (US)

(72) Inventors: Jesse L. Farinacci, Buffalo, NY (US); Marc A. Martin, Secaucus, NJ (US)

(73) Assignee: International Business Machines Corporation, Armonk, NY (US)

(21) Appl. No.: 14/192,000

(22) Filed: Feb. 27, 2014

(51) Int. Cl. G06F 17/30; H04L 29/06

(52) U.S. Cl. CPC G06F 17/3053; H04L 65/00

(57) ABSTRACT

Embodiments relate to supporting development or maintenance of a product. An aspect includes identifying, by a computing device, a plurality of users. Another aspect includes establishing, by the computing device, an environment configured to provide substantially real-time collaboration between the identified users in connection with the product. The development or maintenance may be based on one or more interfaces or fields.

### BACKGROUND

The present invention relates generally to computing technology, and more specifically, to socially integrated operations associated with testing and quality assurance.

Developing and maintaining a product, such as software (e.g., an operating system (OS)), can incorporate or involve the use of many resources. For example, people in different roles (e.g., developers, test engineers, quality control engineers, etc.) may use a variety of equipment (e.g., design tools, test equipment, data loggers, etc.) as part of the effort. The product itself may be associated with a number of different release points or versions. A large number of variables and data are involved. Management of these variables/data is necessary in order to ensure product integrity and efficiency.

In order to provide such management or oversight, conventional techniques utilize checkpoints, wherein a first person updates a record or file and other people can only view or observe stale data until at least the first person closes out of the record or file. Alternatively, people involved in the product development or maintenance would need to schedule a meeting or conference call to review status or provide any updates to the status.

### SUMMARY

Embodiments include a method, system, and computer program product for supporting development or maintenance of a product. In an embodiment, a method comprises identifying, by a computing device, a plurality of users. The method comprises establishing, by the computing device, an environment configured to provide substantially real-time collaboration between the identified users in connection with the product.

In an embodiment, a computer program product for supporting development or maintenance of a product is provided. The computer program product comprises a computer readable storage medium having program instructions embodied therewith, the program instructions readable by a processing circuit to cause the processing circuit to perform a method. The method comprises identifying, by a processor, a plurality of users. The method comprises establishing, by the processor, an environment configured to provide substantially real-time collaboration between the identified users in connection with the product.

In an embodiment, a computer system for supporting development or maintenance of a product is provided. The system comprises a memory having computer readable instructions. The system comprises a processor configured to execute the computer readable instructions. The instructions comprise identifying a plurality of users. The instructions comprise establishing an environment configured to provide substantially real-time collaboration between the identified users in connection with the product.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a computing system environment in accordance with an embodiment;

FIG. 2 depicts an exemplary interface in accordance with one or more embodiments; and

FIG. 3 depicts a process flow in accordance with an embodiment.

### DETAILED DESCRIPTION

In accordance with one or more embodiments, systems, apparatuses, and methods are described that generate a user interface (UI) for workloads, such as workloads associated with a product (e.g., software). Users (e.g., developers or test engineers) may gain access to information associated with the product. The users may collaborate with one another in real-time or substantially in real-time. In some embodiments, data or information may be presented in a chronological fashion or manner. The data may be obtained from one or more sources, potentially in connection with the use of one or more extensions, add-ons, or plug-ins. The data may be stored on one or more servers, potentially in connection with a cloud computing environment.

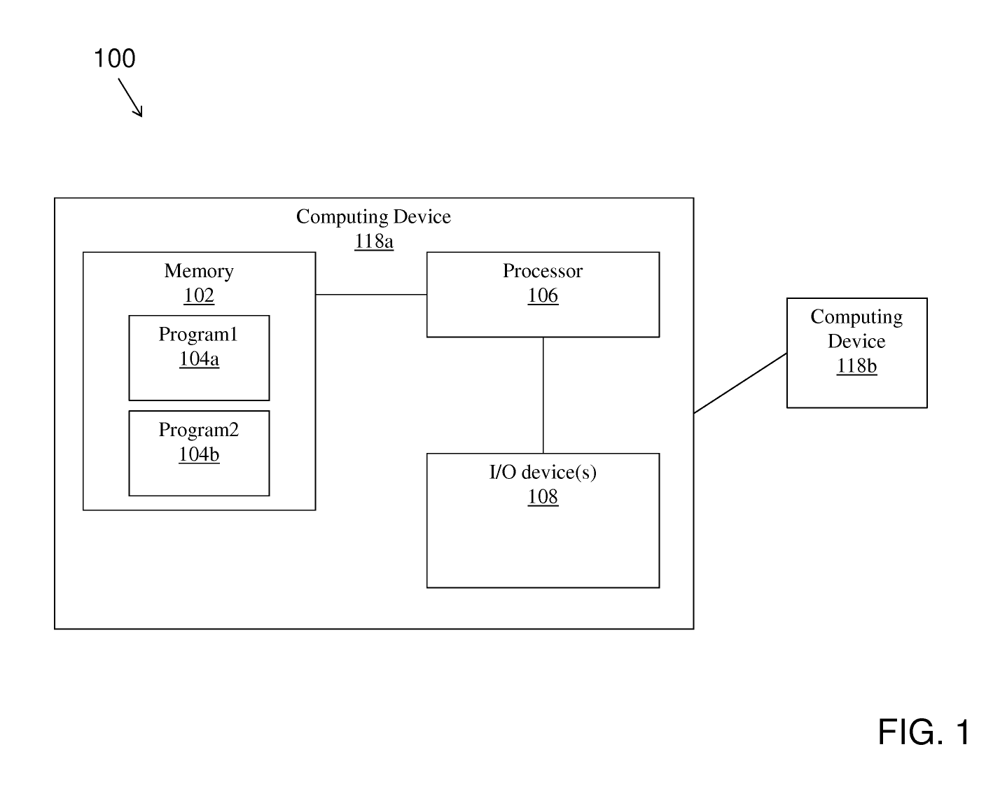

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, procedures, methods, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 108 may be configured to provide an interface to allow a user to interact with the system 100.

In some embodiments, one or more of the entities and devices described above may be associated with a computing device, such as a computing device 118a. The computing device 118a may include a server.

In some embodiments the system 100 may be associated with one or more networks, such as one or more computer or telephone networks. The network(s) may be used to communicatively couple the first computing device 118a and one or more other computing devices, such as a second computing device 118b.

The system 100 is illustrative. In some embodiments, one or more of the entities may be optional. In some embodiments, additional entities not shown may be included. In some embodiments, the entities may be arranged or organized in a manner different from what is shown in FIG. 1.

The system 100 may provide a framework to facilitate the design and maintenance of a product, such as software (e.g., an operating system (OS)). The system 100 may allow groups of people, potentially remotely located from one another, to collaborate with one another in (substantially) real-time. The system 100 may help to centralize the maintenance of data or information associated with any development, maintenance, or troubleshooting activities. In this manner, best-practices or techniques developed over time may be leveraged amongst those participating in the collaboration.

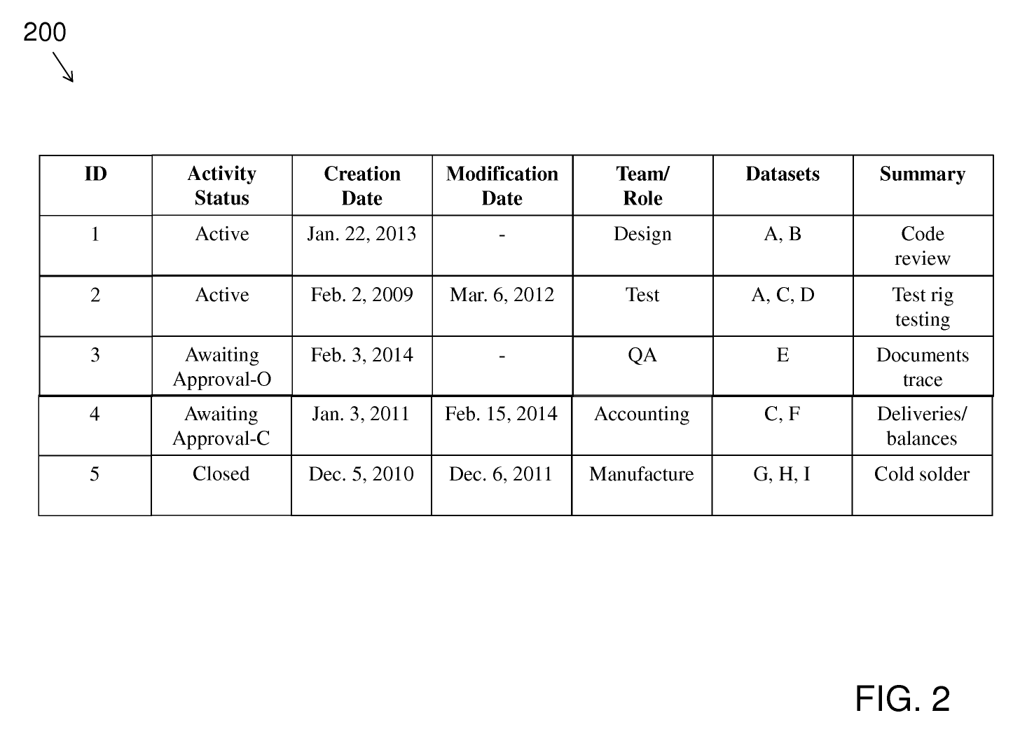

Turning to FIG. 2, an exemplary interface 200 is shown. The interface 200 may be included as part of one or more programs or databases and may be presented on a display screen as part of an I/O interface. The interface 200 is shown in FIG. 2 in a tabular form. One skilled in the art would appreciate that the information included in the interface 200 may be presented in other formats.

The interface 200 is shown as including seven fields, denoted as: (1) identifier (ID), (2) activity status, (3) creation date, (4) modification date, (5) team/role, (6) datasets, and (7) summary. These fields are merely exemplary. In some embodiments, one or more of the fields that are shown may be optional. In some embodiments, additional fields not shown may be included. For example, a priority field may be used to rank the importance of an entry, and a message field may be used to capture messages from members associated with the team/role field.

The ID field may be used to distinguish one entry in the interface 200 from another entry in the interface 200. For illustrative simplicity, five entries are shown in FIG. 2, with the five entries having been assigned an ID value ranging from one to five. Other formats for the ID field may be used, such as alphanumeric values.

The activity status field may be used to denote a status associated with the respective entry in the table. In FIG. 2, IDs 1 and 2 are associated with an “active” status, which may indicate that there is still work left to be performed in connection with those entries. ID 3 may be associated with an “awaiting approval-o” status, which may indicate that approval (e.g., management approval) is needed to initiate work in connection with that entry. ID 4 may be associated with an “awaiting approval-c” status, which may indicate that the work has effectively been performed/completed and approval (e.g., management approval) is needed to formalize the closure of the work. ID 5 may be associated with a “closed” status, which may indicate that the work associated with the entry has been formally closed.

The creation date field may be used to denote when the respective entry was created. The creation date field may correspond to when an interest was expressed to initiate the entry or may correspond to the date that the entry was allocated within a tracking platform or system.

The modification date field may be used to indicate the last date that work or a task was performed in connection with an entry.

The team/role field may be used to indicate a sub-group or sub-organization of people within a larger group or organization assigned to work on an entry. Thus, as shown in FIG. 2, a design team may be assigned to work on the first entry, a test team may be assigned to work on the second entry, a quality assurance (QA) team may be assigned to work on the third entry, an accounting team may be assigned to work on the fourth entry, and a manufacturing team may be assigned to work on the fifth entry.

The datasets field may be used to indicate sets of data associated with the performance of a task associated with a given entry. The datasets may represent prospective datasets that the personnel associated with the team/role field have identified to apply with respect to the entry. The datasets may represent historical datasets that the personnel associated with the team/role field have applied with respect to the entry. In FIG. 2, the datasets are denoted using “dummy” letters A-I. One skilled in the art would appreciate that the datasets could be denoted using more descriptive naming conventions.

The summary field may be used to indicate any work or tasks that have been performed or still need to be performed in connection with the entry. For example, in connection with: (1) the first entry, the design team may perform a code review, (2) the second entry, the test team may place a product on a test rig and subject the product to varying thermal and vibratory environments, (3) the third entry, the QA team may perform a documents trace to ensure that documents are complete and no contradictions exist, (4) the fourth entry, the accounting team may perform a review to ensure that customer balances are cleared and product that has been ordered by the customer have been timely shipped, (5) the fifth entry, the manufacturing team may have determined that a product could be enhanced by checking for cold solder joints prior to shipment.

In some embodiments, one or more of the fields may be enhanced. For example, one or more of the fields or values associated with a field may be converted to a link. When a computer mouse is placed over the link, a short blurb may be displayed that may provide information regarding that field or value. In some embodiments, the link may correspond to a so-called “click through link” that may be configured to orchestrate or organize any equipment or tool sets needed to perform a given workload or task.

In some embodiments, selecting a given field, or a given value within a field, may cause additional information or data to be presented that relates to the selection. In this manner, the degree of data or information that is presented at any given point in time may be regulated or controlled. Such control may be used to: (1) avoid over-burdening a user with excessive or irrelevant information, while (2) ensuring that the user has access to any information or data at any level of abstraction needed to inform a decision-making process.

As described above in connection with FIG. 2, users may be able to collaborate with one another in real-time in connection with one or more tasks. Such collaboration may occur on the basis of one or more groups or teams.

In some embodiments, the information or data that is presented to users may be arranged in a given order. As an example, information may be presented in a chronological order, in a priority order based on a ranking, based on teams/roles, etc.

In some embodiments, information or data that is presented to users may be based on information or data obtained as part of one or more system discovery techniques. For example, a configuration associated with a test rig, such as a product version number, an identification of test equipment parameters (e.g., test computers used, temperature settings or measurements, vibration settings or measurements, etc.), may be obtained and recorded. Such system discovery techniques may be automated so as to alleviate a user of the burden of having to enter such data or information.

In some embodiments, data or information may be obtained from one or more sources. Such data may be obtained via the use of one or more extensions, add-ons, or plug-ins with respect to an existing system, application, or environment.

In some embodiments, one or more servers may be used to store an application, such as an application associated with the interface 200. The servers may be arranged in connection with a cloud computing environments. Any changes made to the data or information associated with the application may be made in the cloud, such that a change made to the data in the cloud may be funneled down to any computing devices that consume the data.

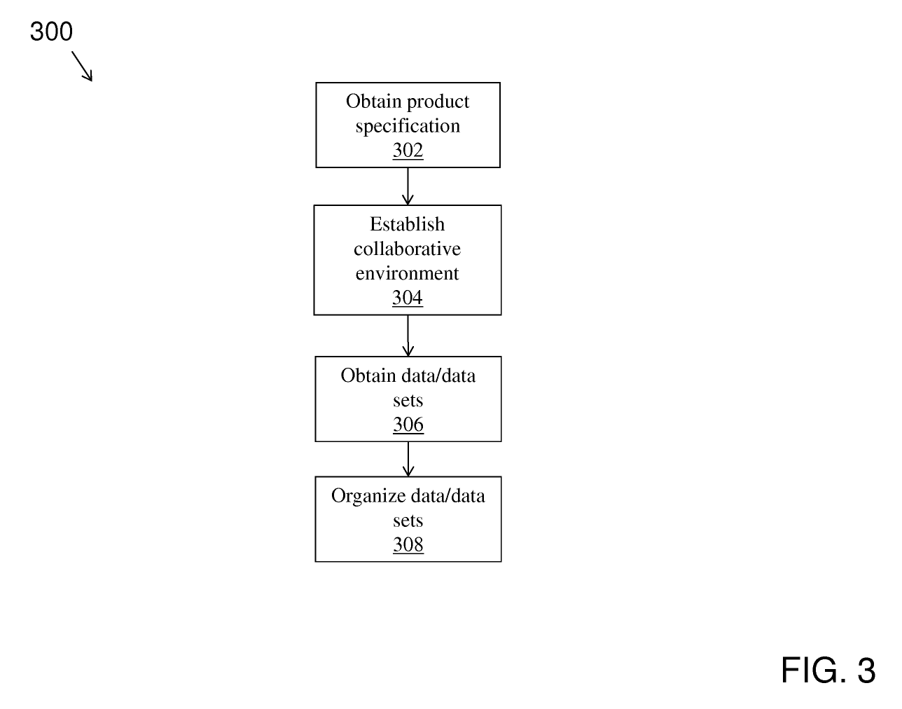

Turning to FIG. 3, a flow chart of a method 300 is shown. The method 300 may be executed by one or more systems, devices, or components, such as those described herein. The method 300 may be used to provide integrated operations in connection with the development or maintenance of a product. Such operations may be performed in a socially integrated manner or fashion.

In block 302, a product specification may be obtained. The product specification may include a listing of requirements associated with the product, such as operational characteristics, reliability requirements, etc.

In block 304, a collaborative environment may be established, potentially in connection with one or more applications. As part of block 304, one or more entries may be opened or created, where each entry may correspond to one or more tasks or workloads to be performed. Fields associated with the collaborative environment may be selected as part of block 304. For example, a designation of users (or teams of users) may be selected as part of block 304.

In block 306, data or datasets needed to support the collaborative environment may be obtained. The data or datasets may be automatically obtained based on one or more discovery techniques, such as those described above. The data or datasets may be obtained from one or more sources, potentially via the use of one or more extensions, add-ons, or plug-ins.

In block 308, the data or datasets may be organized. For example, as part of block 308, the datasets may be arranged in a chronological order.

The method 300 is illustrative. In some embodiments, one or more of the blocks, or a portion thereof, may be optional. In some embodiments, additional blocks or operations not shown may be included. In some embodiments, the blocks may execute in an order or sequence that is different from what is shown in FIG. 3.

In some embodiments, a user interface (UI) or graphical UI (GUI) may create and control workloads or tasks. Such workloads or tasks may access other tools (e.g., third party tools) to manage or control data or datasets associated with the workloads or tasks. In some embodiments, users may create run logs to streamline testing approaches and to facilitate collaboration over new functions or releases in connection with a product. Capital costs may be reduced, resulting in greater efficiency in terms of time and money. Similarly, end-users may be alleviated of the need to collect or obtain information regarding configuration, networking details, logs, etc., and can focus or redirect their efforts towards product use or implementation.

Technical effects and benefits include the provisioning of a collaborative work environment wherein users can obtain data and status regarding a task or workload in substantially real-time, even if the users are remotely located from one another. Such data access/availability may be needed to provide for efficient development or maintenance, particularly where the product is large or complex.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for supporting development or maintenance of a product, the method comprising:
identifying, by a computing device, a plurality of users; and
establishing, by the computing device, an environment configured to provide substantially real-time collaboration between the identified users in connection with the product.

2. The method of claim 1, wherein the plurality of users are identified in connection with at least one of: a team and a role.

3. The method of claim 1, further comprising:
obtaining, by the computing device, a dataset associated with the product; and
populating, by the computing device, the dataset in the environment.

4. The method of claim 3, wherein the dataset is automatically obtained based on use of a discovery technique.

5. The method of claim 3, wherein the dataset is obtained via use of at least one of: an extension to the environment, an add-on to the environment, and a plug-in to the environment.

6. The method of claim 3, further comprising:
arranging, by the computing device, data included in the dataset in an order,
wherein the order is based on at least one of: a chronological order, a priority order based on a ranking, an identification of one or more teams, and an identification of one or more roles.

7. The method of claim 1, further comprising:
transmitting, by the computing device, information associated with the environment to a second computing device over at least one network.

8. A computer program product for supporting development or maintenance of a product, the computer program product comprising:
a computer readable storage medium having program instructions embodied therewith, the program instructions readable by a processing circuit to cause the processing circuit to perform a method comprising:
identifying, by a processor, a plurality of users; and
establishing, by the processor, an environment configured to provide substantially real-time collaboration between the identified users in connection with the product.

9. The computer program product of claim 8, wherein the plurality of users are identified in connection with at least one of: a team and a role.

10. The computer program product of claim 8, the method further comprising:
obtaining, by the processor, a dataset associated with the product; and
populating, by the processor, the dataset in the environment.

11. The computer program product of claim 10, wherein the dataset is automatically obtained based on use of a discovery technique, and wherein the dataset includes data related to a configuration of the product and a configuration of test equipment used to test the product.

12. The computer program product of claim 10, wherein the dataset is obtained via use of at least one of: an extension to the environment, an add-on to the environment, and a plug-in to the environment.

13. The computer program product of claim 10, the method further comprising:
arranging, by the processor, data included in the dataset in an order,
wherein the order is based on at least one of: a chronological order, a priority order based on a ranking, an identification of one or more teams, and an identification of one or more roles.

14. The computer program product of claim 10, wherein data included in the dataset comprises messages between the users.

15. The computer program product of claim 8, the method further comprising:
transmitting, by the processor, information associated with the environment to a computing device over at least one network.

16. A computer system for supporting development or maintenance of a product, the system comprising:
a memory having computer readable instructions; and
a processor configured to execute the computer readable instructions, the instructions comprising:
identifying a plurality of users; and
establishing an environment configured to provide substantially real-time collaboration between the identified users in connection with the product.

17. The computer system of claim 16, wherein the environment comprises an application, the instructions comprising:
transmitting information associated with the application to a computing device.

18. The computer system of claim 16, wherein the product comprises a software product, and wherein the software product comprises an operating system.

19. The computer system of claim 16, wherein the environment is associated with a plurality of fields, the instructions comprising:
enhancing at least one of:
at least one of the fields, and
at least one value associated with at least one of the fields.

20. The computer system of claim 19, wherein the enhancement comprises a conversion to a click through link, wherein the click through link is configured to organize equipment or tool sets needed to perform a given workload or task.
